(19) United States
(12) Patent Application Publication
(10) Pub. No.: US 2011/0126854 A1
(43) Pub. Date: Jun. 2, 2011

(54) 3-in-1 Mitt

(76) Inventor: Phillip Frey, Saint James, MO (US)

(21) Appl. No.: 12/958,020

(22) Filed: Dec. 1, 2010

Related U.S. Application Data
(60) Provisional application No. 61/266,027, filed on Dec. 2, 2009.

(51) Int. Cl. B08B 1/00; B08B 3/00

(52) U.S. Cl. 134/6; 401/261

(57) ABSTRACT

An architecture is presented that provides a cleaning device for vehicles, windows, pets, etc. The cleaning device comprises a mitt to be worn by a user, and a swivel extension secured in the center of the mitt. The swivel extension connects to a coil hose, which will supply water to the mitt eliminating the need for a soap/wash bucket. Specifically, a threaded connector on an end of the coil hose allows the hose to be connected to a water supply, such as a garden hose or faucet. Furthermore, the mitt has an opening in the center, wherein soap can be inserted. Once soap is inserted into the center of the mitt, the opening can be secured with hook and loop fasteners, or any other suitable fasteners. The mitt also comprises an adjustable collar, allowing the mitt to be tightened and secured to a user's hand.

### CROSS-REFERENCE

This application claims priority from Provisional Patent Application Ser. No. 61/266,027 filed Dec. 2, 2009.

### BACKGROUND

Traditionally, there are many different steps that go into washing pets, vehicles, windows, or other objects. For example, many individuals utilize a bucket and a cloth to apply the soap or cleaning agent. However, it can be very inconvenient and time consuming to constantly return to the bucket for soapy water. It is also common to use a garden hose as a water source. This can be overwhelming for users, as a garden hose can be difficult to maneuver, which often results in an unruly flow of water. Additionally, it is often necessary to hold onto one's pet while washing them. However, without a free hand, the pet may run loose. Accordingly, a more efficient method is needed for cleaning objects.

Consequently, a need exists for a cleaning device for pets, vehicles, windows, etc. The proposed invention allows a user to clean objects with ease and efficiency. The device incorporates a small hose which will supply water to a mitt containing soap, eliminating the need for a soap bucket and effectively conserving water. Thus, allowing a user to maximize their cleaning abilities in less time, saving the user time and energy.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a cleaning device for vehicles, windows, pets, etc. The cleaning device comprises a mitt to be worn by a user, and a swivel extension secured in the center of the mitt. The swivel extension connects to a coil hose, which will supply water to the mitt eliminating the need for a soap/wash bucket. Specifically, a threaded connector on an end of the coil hose allows the hose to be connected to a water supply, such as a garden hose or faucet to supply water to the mitt.

Furthermore in the preferred embodiment of the present invention, the mitt has an opening in the center, wherein soap can be inserted. Once soap is inserted into the center of the mitt, the opening can be secured with hook and loop fasteners, or any other suitable fasteners. Furthermore, the mitt comprises an adjustable collar, allowing the mitt to be tightened and secured to a user's hand. Thus, the mitt can fit all users regardless of size.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a rear view of a cleaning device.

FIG. 2 illustrates a rear view of the cleaning device wherein soap is being inserted in the opening of the mitt.

FIG. 3 illustrates a rear view of the cleaning device wherein the adjustable collar is being adjusted to fit a user.

FIG. 4 illustrates a perspective view of a user using the cleaning device to clean a vehicle.

FIG. 5 illustrates a perspective view of the user using the cleaning device to clean a pet.

FIG. 6 illustrates a method of cleaning vehicles, windows, or pets with the cleaning device.

FIG. 7 illustrates further aspects in the cleaning method of FIG. 6.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

Typically, cleaning pets, vehicles, windows and other objects can be inefficient and time-consuming. For example, the garden hose can be overwhelming and difficult to maneuver, resulting in an unruly flow of water. Further, it may be necessary to hold onto your pet with one hand while attempting to wash the pet with your other hand. And, it can be inconvenient and time consuming to utilize a bucket and a cloth to apply soap or other cleaning agents. The disclosed cleaning device assists users in washing objects with ease and efficiency.

The disclosed cleaning device allows for a user to maximize their cleaning abilities in less time. The cleaning device comprises a mitt to be worn by a user, and a swivel extension secured in the center of the mitt. The swivel extension connects to a coil hose, which will supply water to the mitt. Specifically, a threaded connector on an end of the coil hose allows the hose to be connected to a water supply, such as a garden hose or faucet. Furthermore, the mitt has an opening in the center, wherein soap can be inserted. The water supply allows water to flow through the coil hose into the mitt, which mixes with the soap to create suds. The cleaning device can then be used for cleaning and eliminates the need for a soap/wash bucket.

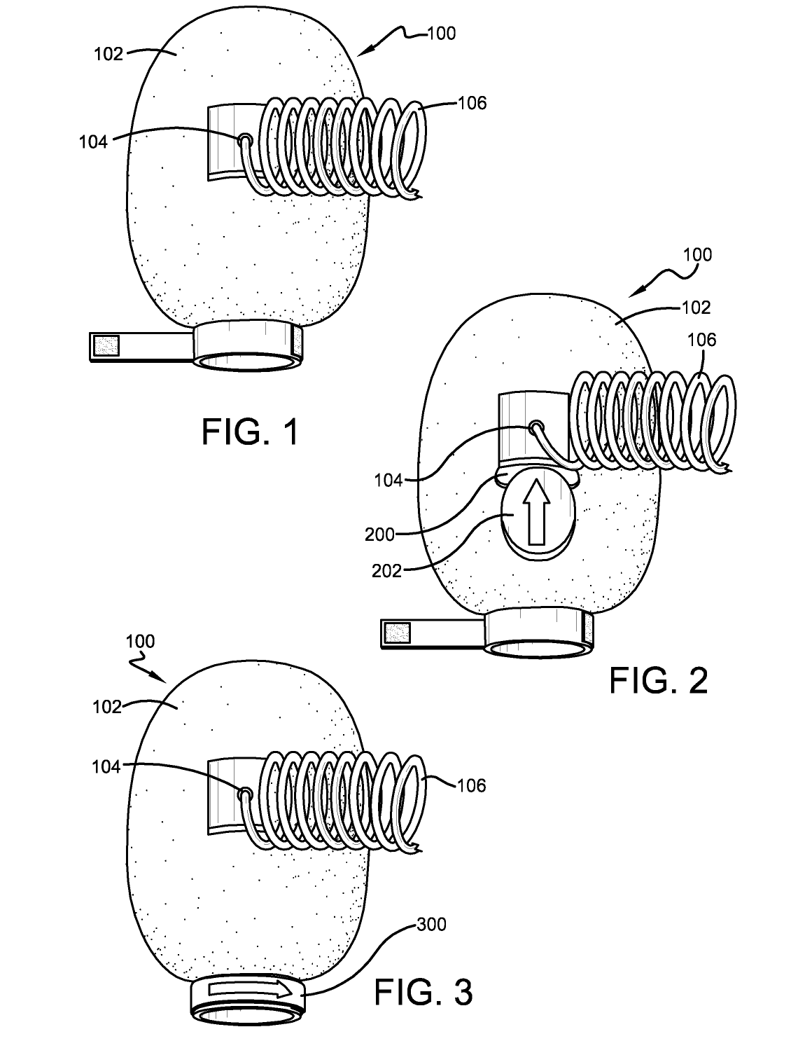

Referring initially to the drawings, FIG. 1 illustrates a cleaning device 100 for cleaning vehicles, windows, pets, etc. The cleaning device 100 can also be used to clean other objects, depending on a user's wants and needs. The cleaning device 100 comprises a mitt 102 worn by a user. The inside of the mitt typically comprises neoprene material, or any other suitable material to keep a user's hand protected from the water. The outside of the mitt typically comprises a non-abrasive material, or any other suitable material that will not damage or injure the object being washed. The mitt 102 comprises a swivel extension 104 secured in the center of the mitt 102 and a hose 106 connected to the swivel extension 104. The swivel extension 104 allows the hose 106 to be easily maneuvered. The hose 106 is typically a ¼″ coil hose. The small diameter of the coil hose 106 allows for the conservation of water when using the cleaning device 100. Further, a threaded connector, or other suitable connecting means is positioned on an end of the coil hose 106 to allow the coil hose 106 to be connected to a water supply (not shown). The water supply is typically a garden hose or faucet but could be any suitable water supply as is known in the art. The water supply allows water to flow through the coil hose 106 into the mitt 102, which supplies water to the mitt 102 for cleaning and eliminates the need for a wash bucket.

FIG. 2 illustrates the cleaning device 100 wherein soap is being inserted in the opening of the mitt. As stated above, the mitt 102 comprises a swivel extension 104 secured in the center of the mitt 102 and a coil hose 106 connected to the swivel extension 104. Further, a threaded connector, or other suitable connecting means is positioned on an end of the coil hose 106 to allow the coil hose 106 to be connected to a water supply (not shown). The water supply allows water to flow through the coil hose 106 into the mitt 102 for cleaning.

Further, the mitt 102 comprises an opening 200 in the center wherein soap 202 can be inserted. Once soap 202 is inserted into the opening 200 of the mitt 102, the opening 200 can be secured with hook and loop fasteners (not shown), or any other suitable fasteners. Once connected to the water supply, water will run through the coil hose 106 into the mitt 102. The soap 202 and water will mix together to create suds for cleaning the object or objects, and will eliminate the need for a soap/wash bucket.

FIG. 3 illustrates the cleaning device 100 wherein the adjustable collar is being adjusted to fit a user. As stated above, the mitt 102 comprises a swivel extension 104 secured in the center of the mitt 102 and a coil hose 106 connected to the swivel extension 104. Further, a threaded connector, or other suitable connecting means is positioned on an end of the coil hose 106 to allow the coil hose 106 to be connected to a water supply (not shown). The water supply allows water to flow through the coil hose 106 into the mitt 102 for cleaning.

Furthermore, the mitt 102 comprises an adjustable collar 300, allowing the mitt 102 to be tightened and secured to a user's hand (not shown). Thus, the mitt 102 can fit all users regardless of size.

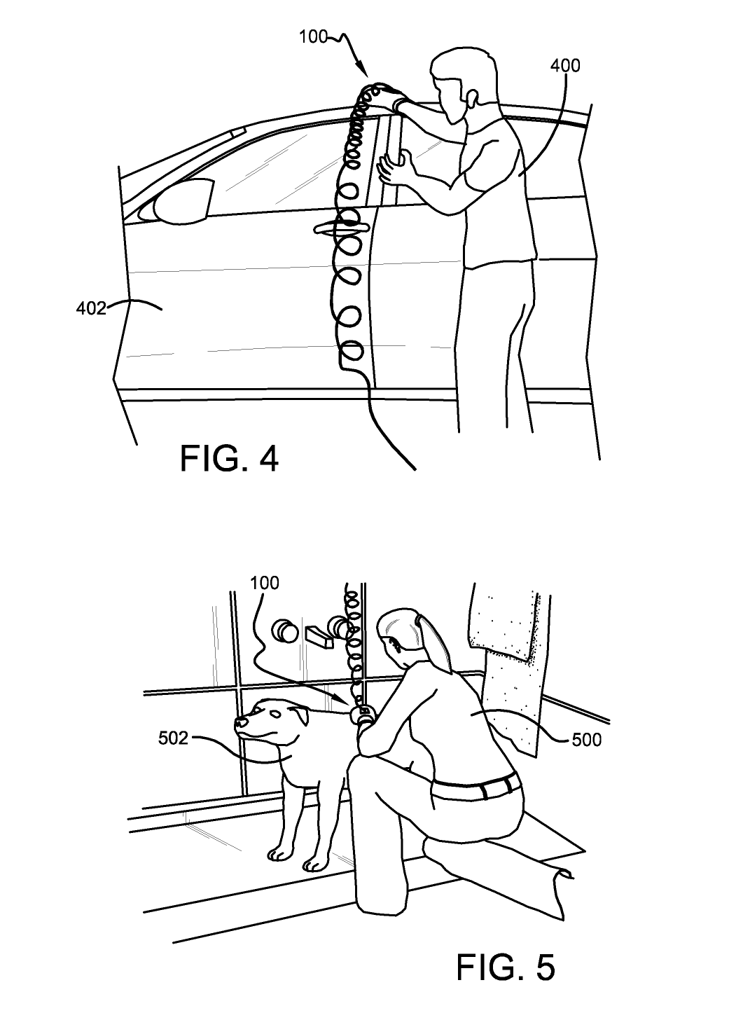

Furthermore, FIGS. 4-5 illustrate the cleaning device 100 in use. FIG. 4 illustrates a user 400 using the cleaning device 100 to clean a vehicle 402. FIG. 5 illustrates a user 500 using the cleaning device 100 to clean a pet 502.

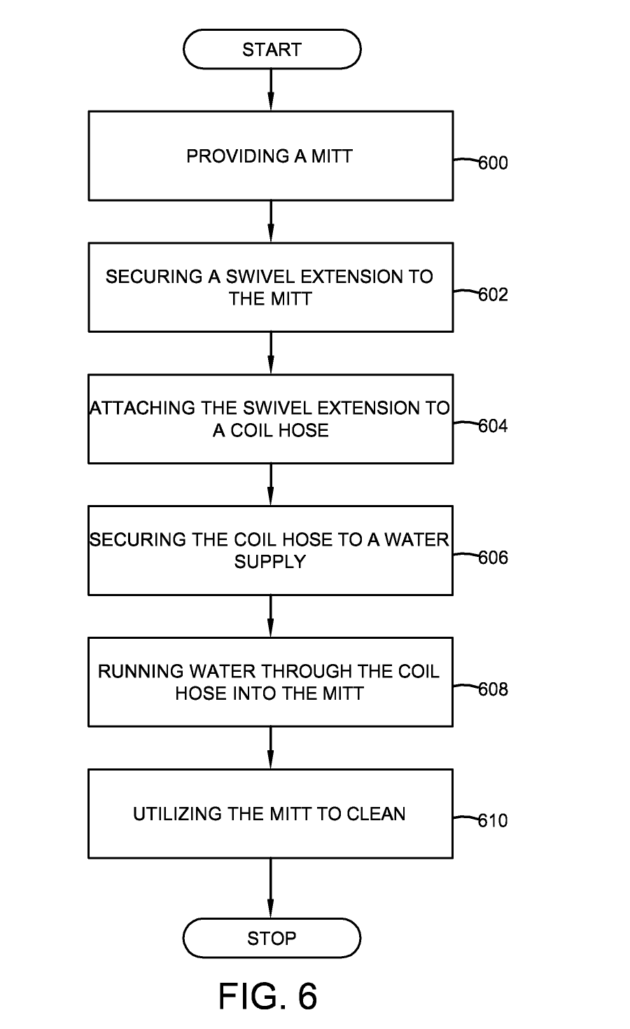

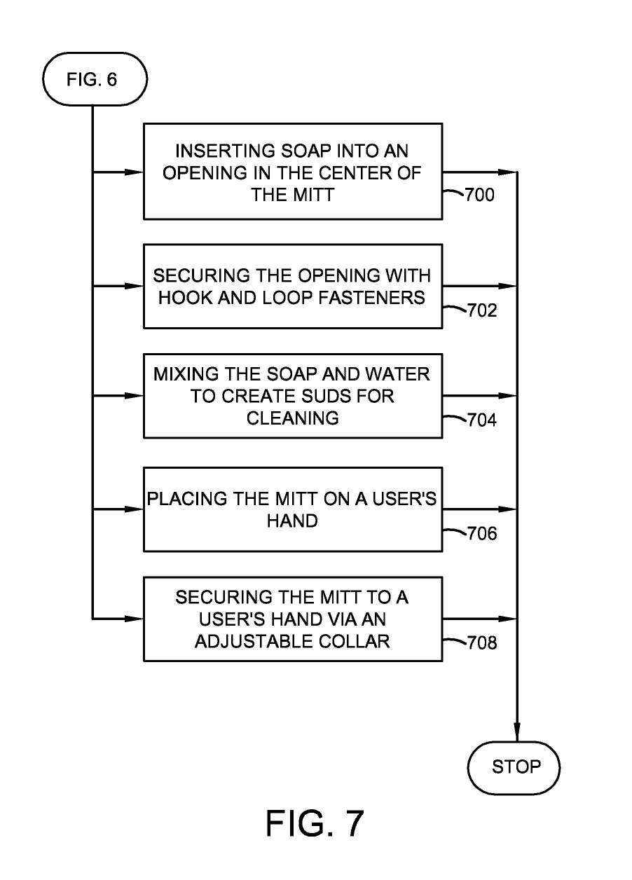

FIGS. 6-7 illustrate methodologies of cleaning vehicles, windows, pets, etc. with a cleaning device, according to various aspects of the innovation. While, for purposes of simplicity of explanation, the one or more methodologies shown herein (e.g., in the form of a flow chart or flow diagram) are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

Referring to FIG. 6, a method of cleaning vehicles, windows, pets, etc. with a cleaning device is illustrated. At 600, a mitt is provided for cleaning. The inside of the mitt typically comprises neoprene material, or any other suitable material to keep a user's hand protected from the water. The outside of the mitt typically comprises a non-abrasive material, or any other suitable material that will not damage or injure the object being washed. At 602, a swivel extension is secured to the mitt. The swivel extension is typically secured to the center of the mitt. At 604, the swivel extension is attached to a coil hose. The swivel extension allows the attached coil hose to be easily maneuvered. The coil hose is typically a ¼″ coil hose. The small diameter of the coil hose allows for the conservation of water when using the cleaning device. At 606, the coil hose is secured to a water supply. A threaded connector, or other suitable connecting means is positioned on an end of the coil hose to allow the coil hose to be connected to a water supply. The water supply is typically a garden hose or faucet but could be any suitable water supply as is known in the art. At 608, water is run through the coil hose into the mitt. And at 610, the mitt is utilized to clean. The water supply allows water to flow through the coil hose into the mitt, which supplies water to the mitt for cleaning and eliminates the need for a wash bucket.

FIG. 7 illustrates further aspects in the cleaning method of FIG. 6. At 700, soap is inserted into an opening in the center of a mitt. Inserting soap into the mitt, allows a user to maximize their cleaning abilities and eliminates the need for a soap/wash bucket. At 702, the opening in the center of the mitt is secured with hook and loop fasteners or any other suitable fasteners. At 704, the soap and water is mixed to create suds. As stated above, the water supply allows water to flow through the coil hose into the mitt, which mixes with the soap to create suds. The mitt can then be used for cleaning and eliminates the need for a soap/wash bucket.

At 706, the mitt is placed on a user's hand. And at 708, the adjustable collar is used to secure the mitt to a user's hand. Specifically, the adjustable collar allows the mitt to be tightened and secured to a user's hand. Thus, the mitt can fit all users regardless of size.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning device comprising:
a mitt to be worn by a user;
a swivel extension secured in center of the mitt; and
a hose that connects to the swivel extension;
wherein a threaded connector on an end of the hose allows the host to be connected to a water supply.

2. The cleaning device of claim 1, further comprising an opening in the center of the mitt where soap is inserted.

3. The cleaning device of claim 2, wherein the opening is secured closed with hook and loop fasteners.

4. The cleaning device of claim 1, wherein the mitt comprises an adjustable collar, allowing the mitt to be tightened and secured to a user.

5. The cleaning device of claim 4, wherein inside of the mitt comprises neoprene material.

6. The cleaning device of claim 5, wherein outside of the mitt comprises a non-abrasive material.

7. The cleaning device of claim 6, wherein the hose is a ¼″ coil hose.

8. The cleaning device of claim 1, wherein the water supply comprises a garden hose or a faucet.

9. A method of cleaning vehicles, windows, or pets, comprising:
providing a mitt;
securing a swivel extension to the mitt;
attaching the swivel extension to a coil hose;
securing the coil hose to a water supply;
running water through the coil hose into the mitt; and
utilizing the mitt to clean.

10. The method of claim 9, further comprising:
inserting soap into an opening in center of the mitt;
securing the opening with hook and loop fasteners; and
mixing the soap and water to create suds for cleaning.

11. The method of claim 10, further comprising:
placing the mitt on a user's hand; and
securing the mitt to a user's hand via an adjustable collar.

12. The method of claim 11, wherein the coil hose is a ¼″ coil hose.

13. The method of claim 12, wherein the water supply comprises a garden hose or faucet.

14. A cleaning system, comprising:
a mitt comprising an opening in center of the mitt for soap and a swivel extension secured to the center of the mitt; and
a coil hose that connects to the swivel extension and to a water supply.

15. The cleaning system of claim 14, wherein an end of the coil hose comprises a threaded connector used to secure the coil hose to the water supply.

16. The cleaning system of claim 15, wherein the water supply comprises a garden hose or faucet.

17. The cleaning system of claim 16, wherein the mitt comprises an adjustable collar for securing the mitt to a user.

18. The cleaning system of claim 17, wherein the opening in the mitt for soap is secured with hook and loop fasteners.

19. The cleaning system of claim 18, wherein inside the mitt comprises neoprene material and outside the mitt comprises a non-abrasive material.

20. The cleaning system of claim 19, wherein the coil hose is a ¼″ coil hose.
